(19) United States
(12) Patent Application Publication
(10) Pub. No.: US 2008/0280472 A1
(43) Pub. Date: Nov. 13, 2008

(54) Controller with an Anti-pull out Structure

(76) Inventors: Chia-Chun Wei, Taichung (TW); Yu-Jian Lin, Taichung (TW)

Correspondence Address: Dr. BANGER SHIA, 102 Lindencrest Ct., Sugar Land, TX, 77479-5201, US

(21) Appl. No.: 11/746,872

(22) Filed: May 10, 2007

(51) Int. Cl. H01R 13/62

(52) U.S. Cl. 439/258

(57) ABSTRACT

A controller with an anti-pull out structure comprises at least one socket and one plug, the anti-pull out structure is formed with the same number of notches as the socket. The notch is used to restrict the plug in the socket of the controller, which not only prevents the plug from falling off but also prevents improper insertion of the plug into the socket of the controller.

### BACKGROUND OF THE INVENTION

1. Field of the Invention

The present invention relates to a controller, and more particularly to a controller with an anti-pull out structure that can not only prevent the plug from falling off but also prevent improper insertion of the plug into the socket of the controller.

2. Description of the Prior Art

A controller must be connected with the plugs of power wires or connecting cables, so that the power wires serve to supply electric power and the connecting cables are provided for transmitting data or signals. Once the plugs fall out of the sockets of the controller, which not only will cause loss of data, and even worse, it will also cause the whole system or machine to stop working, so the loss will be great.

Accordingly, several types of anti-pull out structure for preventing the plug from falling out of the socket of the controller appeared on the market, let's take two of them as examples, as shown in FIGS. 1 and 2. An anti-pull out structure as shown in FIG. 1 comprises an upper stopping block 10 and a lower stopping block 20, one end of the upper stopping block 10 is connected to the end of the lower stopping block 20 to form a unitary structure. The other end of the upper stopping block 10 is formed with an engaging groove 11 to be engaged with a hook 21 of the other end of the lower stopping block 20. A stopping piece 12 extending toward the lower stopping block 20 is formed at one side of the upper stopping block 10.

When a plug A with a peripheral flange A1 is plugged in the socket of the controller, the anti-pull out structure is fixed on the controller by engaging the engaging groove 11 of the upper stopping block 10 with the hook 21 of the lower stopping block 20. At the same time, the stopping piece 12 of the upper stopping block 10 cooperates with the peripheral flange A1 to stop the plug A from being pulled out of the socket of the controller.

However, this type of anti-pull out structure is not easy to disassemble since the hook 21 of the lower stopping block 20 is engaged in the engaging groove 11 of the upper stopping block 10. In addition, multiple times of disassembly will cause deformation or even rupture of the lower stopping block 20.

Another anti-pull out structure is shown in FIG. 2, the plug C is formed with two engaging members C1 that are located in the direction of the socket B1 of the controller B. Each of the engaging members C1 has a hook C2, and in the socket B1 are defined two through holes B2 for engaging with the hooks C2 of the two engaging members C1. When the plug C is plugged in the socket B1, the hooks C2 of the two engaging members C1 are engaged in the two through holes B2 of the socket B1, so as to prevent the plug C from being pulled out of the socket B1 of the controller B.

This anti-pull out structure cannot be used with general plugs but the special plug C and the controller B. In disassembly, the hooks C2 of the engaging members C1 of the plug C must be unlocked firstly, and then the plug C can be pulled out, it is troublesome. In order to define the two through holes B2 for engaging with the hooks C2 of the engaging members C1, the socket B1 must protrude out of the controller B, this will not only adversely affect the appearance, but cause many more problems as compared with the previous anti-pull out structure.

The present invention has arisen to mitigate and/or obviate the afore-described disadvantages.

### SUMMARY OF THE INVENTION

The primary objective of the present invention is to provide a controller with an anti-pull out structure that can prevent the plug from falling off.

The secondary objective of the present invention is to provide a controller with an anti-pull out structure that can prevent improper insertion of the plug into the socket of the controller.

A controller with an anti-pull out structure in accordance with the present invention comprises at least one socket and at least one plug detachably plugged in the socket. The anti-pull out structure is defined with at least one notch being located correspondingly to the socket of the controller, and the notch is formed correspondingly to the plug.

When the plug is inserted in the socket of the controller, the anti-pull out structure is assembled on the controller and located correspondingly to the socket, and the notch is used to restrict the plug in the socket of the controller, thus preventing the plug from falling out of the socket.

Since the notch of the anti-pull out structure is formed correspondingly to and employed to restrict the plug, the plug must be properly inserted in the socket of the controller, so that the notch of the anti-pull out structure can snugly fit the plug, and the anti-pull out structure can fit onto the controller. Therefore, it can prevent improper insertion of the plug into the controller.

The plug is formed with a peripheral flange, the notch of the anti-pull out structure is engaged with the peripheral flange, so as to position the anti-pull out structure.

The controller is defined with at least one positioning concave, and a concave direction of the positioning concave intersects an inserting direction of the socket, the anti-pull structure is formed with the same number and shape of convex portion as the positioning concave, so that the anti-pull out structure is detachably assembled on the controller. The concave direction of the positioning concave can also be vertical to the inserting direction of the socket to improve the effect of positioning the plug.

The positioning concave is formed at either end of the controller, and the convex portion is formed at either end of the anti-pull out structure, so as to enable the anti-pull out structure to be assembled on the controller more firmly.

The controller is formed with two protrusions that extend in opposite directions, the extending direction of the protrusions intersects the inserting direction of the socket, and the anti-pull structure is defined with two cavities for mating with the two protrusions of the controller. Such arrangements further improve the assembling strength between the anti-pull out structure and the controller. Further, the extending direction of the protrusions can also be vertical to the inserting direction of the socket to improve the effect of positioning the plug.

One end of the anti-pull out structure is pivotally disposed on the controller, and the other end of the anti-pull out structure is formed with at least one elastic engaging member, the controller is formed with the same number and shape of engaging portions as the elastic engaging members, so that the anti-pull out structure is rotatably, openably and closably secured to the controller.

### BRIEF DESCRIPTION OF THE DRAWINGS

FIG. 1 is a perspective view of a conventional anti-pull out structure;

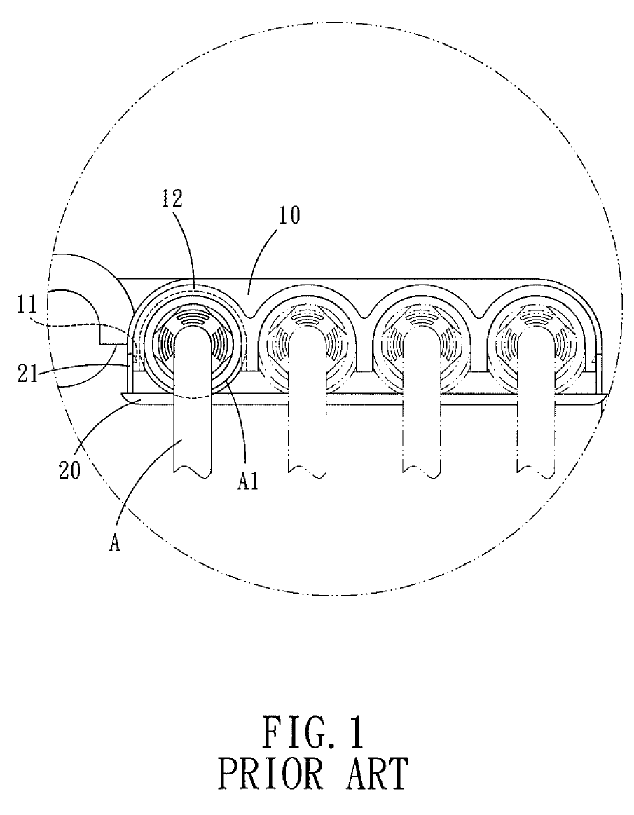

FIG. 2 is a perspective view of another conventional anti-pull out structure;

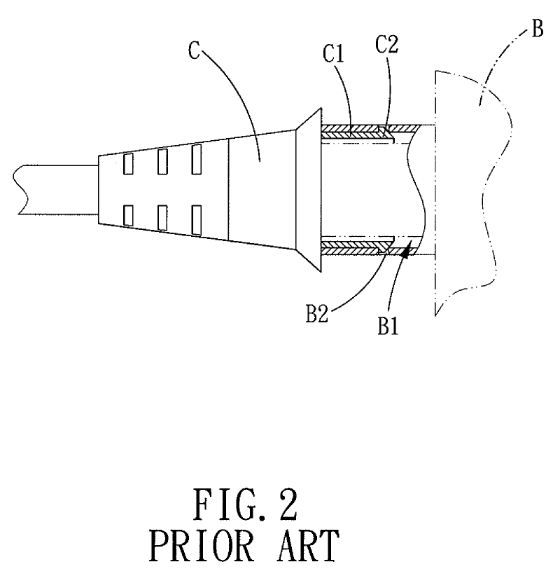

FIG. 3 is an exploded view of a controller with an anti-pull out structure in accordance with the present invention;

FIG. 4 is an assembly view of the controller with an anti-pull out structure in accordance with the present invention;

FIG. 5 is a perspective view of the convex portion and the cavity of the anti-pull out structure in accordance with the present invention;

FIG. 6 shows that the anti-pull out structure in accordance with the present invention is assembled on the controller to restrict the plug;

FIG. 7 is a perspective view of FIG. 6 from another angle;

FIG. 8 is a perspective view of a controller with an anti-pull out structure in accordance with another embodiment of the present invention, wherein the anti-pull out structure is pivotally secured to the controller;

FIG. 9 is a perspective view of the controller with an anti-pull out structure in accordance with the another embodiment of the present invention, wherein the anti-pull out structure opens, and the plug is plugged in the controller; and

FIG. 10 shows the closed state of the anti-pull out structure of FIG. 9.

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

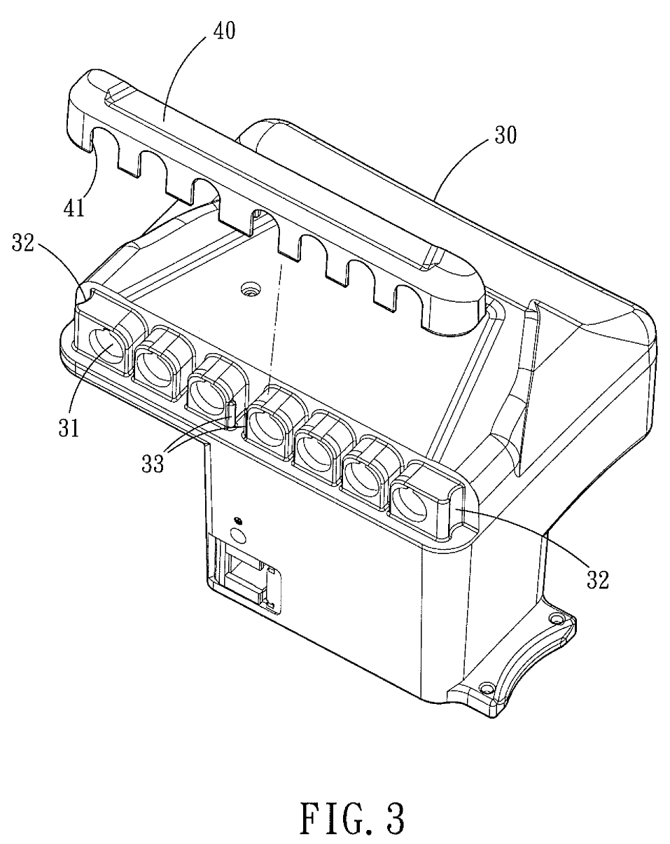

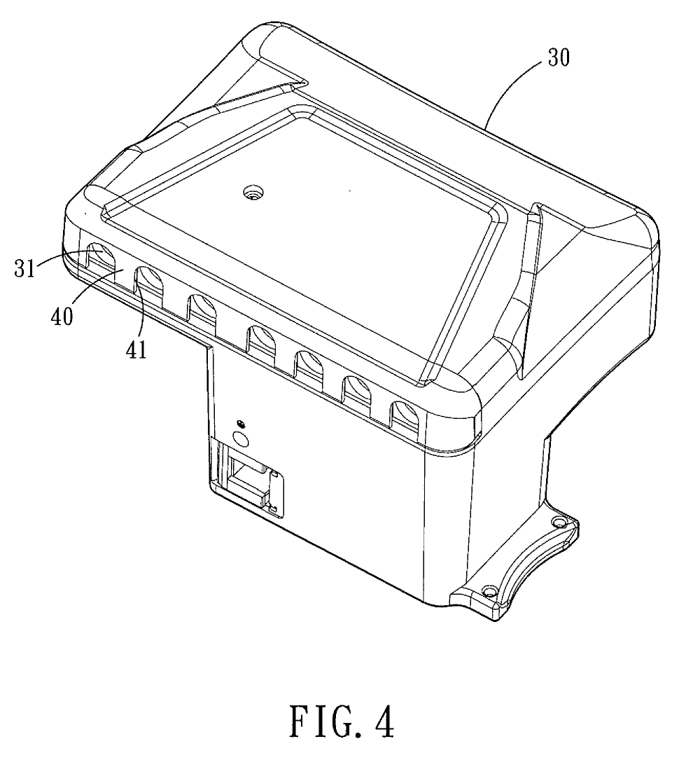

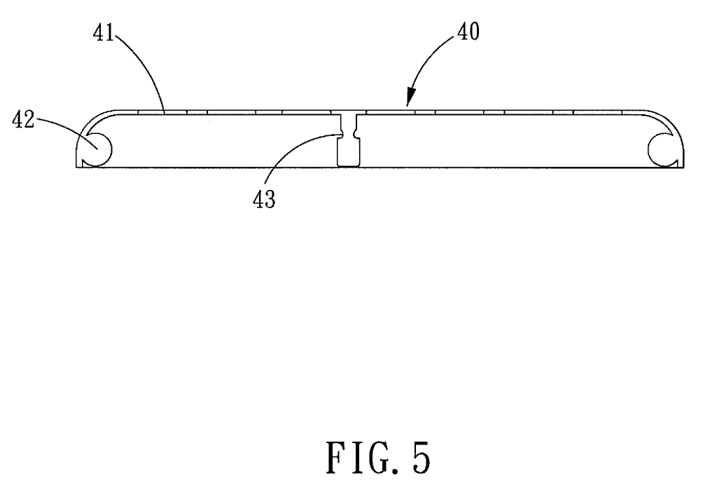

Referring to FIGS. 3-7, a controller 30 with an anti-pull out structure 40 in accordance with a preferred embodiment of the present invention comprises a plurality of sockets 31 and plugs S to be plugged into the sockets 31. In this embodiment, the controller 30 is defined at either end thereof with a positioning concave 32, and the concave direction of the positioning concave 32 is vertical to the inserting direction of the sockets 31. The controller 30 is further formed with two protrusions 33 that extend in opposite directions, and the extending directions of the protrusions 33 are also vertical to the inserting direction of the sockets 31.

The anti-pull structure 40 is positioned in the sockets 31 of the controller 30 and is formed with the same number and shape of notches 41 as the sockets 31. The notches 41 of the anti-pull out structure 40 and the outer periphery of the plugs S have similar shapes. The anti-pull structure 40 is defined with two convex portions 42 with shapes corresponding to those of the two positioning concaves 32 of the controller 30 and is further formed with two cavities 43 with shapes corresponding to the two protrusions 33 of the controller 30. Through the engagement of the convex portions 42 and the cavities 43 with the positioning concaves 32 and the protrusions 33, the anti-pull out structure 40 is detachably mounted on the controller 30.

When the plugs S are inserted in the sockets 31 of the controller 30, and the anti-pull out structure 40 is mounted on the controller 30, the notches 41 of the anti-pull out structure 40 can restrict the plugs S within the sockets 31 of the controller 30.

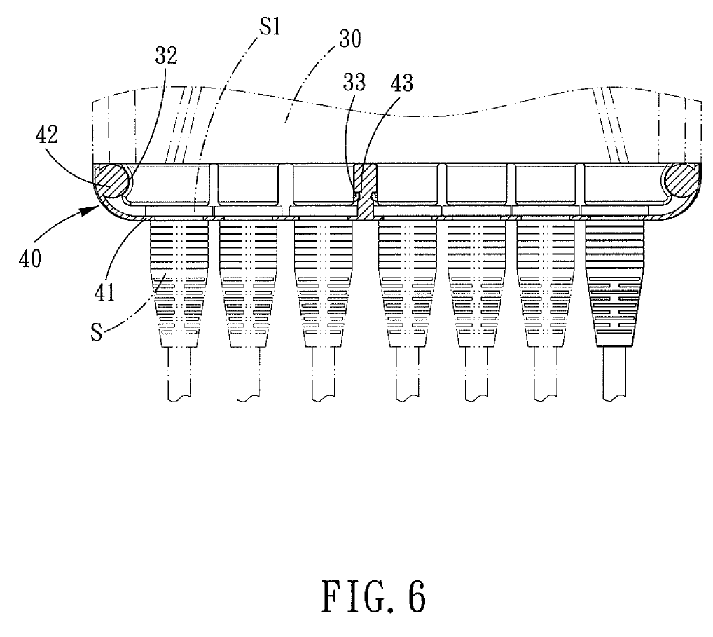

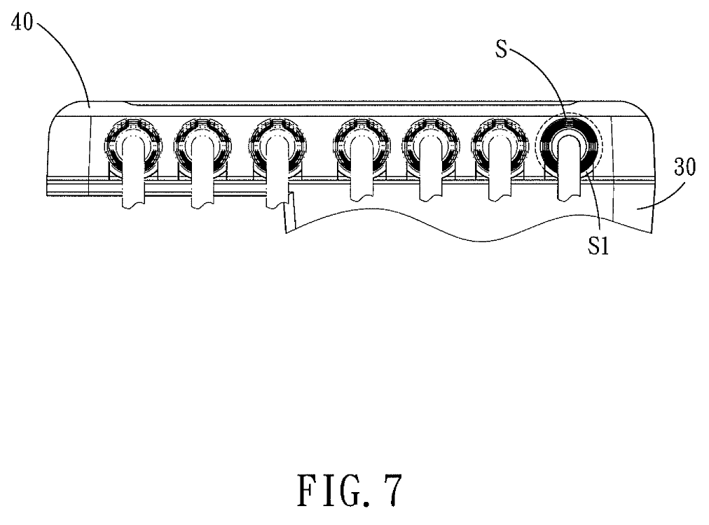

As shown in FIGS. 6 and 7, the concave direction of the positioning concaves 32 and the extending direction of the protrusions 33 of the controller 30 are vertical to the inserting direction of the sockets 31. When the anti-pull out structure 40 is mounted on the controller 30, the convex portions 42 and the cavities 43 are engaged with the positioning concaves 32 and the protrusions 33. Therefore, the assembly direction of the anti-pull out structure 40 is also vertical to the inserting direction of the sockets 31. When the plugs S with the peripheral flange S1 are inserted in the sockets 31, and the anti-pull out structure 40 is mounted on the controller 30, the peripheral flange S1 of the plugs S will be restricted between the notches 41 of the anti-pull out structure 40 and the sockets 31 of the controller 30. In addition, the pull-out direction of the plugs S is vertical to the disassembly direction of the anti-pull out structure 40, when pulling the plugs S, the peripheral flange S1 of plugs S will be stopped by the notches 41 of the anti-pull out structure 40, so that the plugs S cannot be pulled out and are restricted between the notches 41 of the anti-pull out structure 40 and the sockets 31 of the controller 30.

From the description above, we can find that when the plugs S are inserted in the sockets 31, and then the anti-pull out structure 40 is mounted on the controller 30, the plugs S can be restricted between the notches 41 of the anti-pull out structure 40 and the sockets 31 of the controller 30, thus preventing the plugs S from falling out of the sockets 31 of the controller 30.

Since the notches 41 of the anti-pull out structure 40 are formed correspondingly to and employed to restrict the plugs S, the plugs S must be properly inserted in the sockets 31 of the controller 30, so that the notches 41 of the anti-pull out structure 40 can snugly fit the plugs S, and the anti-pull out structure 40 can fit onto the controller 30. Therefore, it can prevent improper insertion of the plug into the controller 30.

The anti-pull out structure 40 of the abovementioned embodiment fits onto the controller 30 in a convex and concave pattern, so it can be disassembled easily without using tools.

Since the anti-pull out structure 40 uses the notches 41 to restrict the plugs S, it can be applied to various types of plugs, unlike some of the conventional anti-pull out structures are applicable to specific plugs and controller only.

Further, the anti-pull out structure 40 is integrally assembled on the controller 30 to form an integral structure, it is not only beauty in appearance, the plugs S of the controller 30 are also hidden in the anti-pull out structure 40 and the controller 30, without the problem that the sockets of the controller of some of the conventional anti-pull out structures must protrude out of the controller.

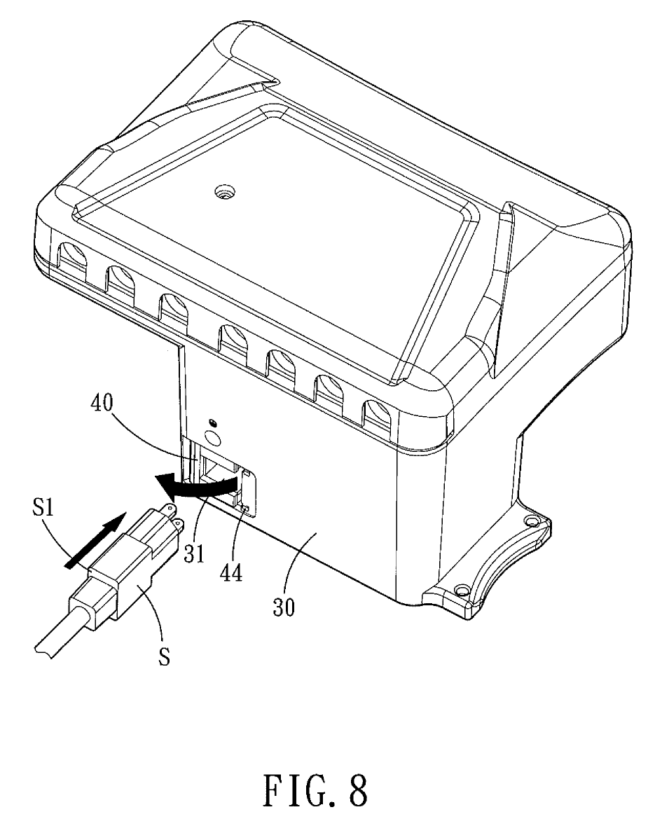

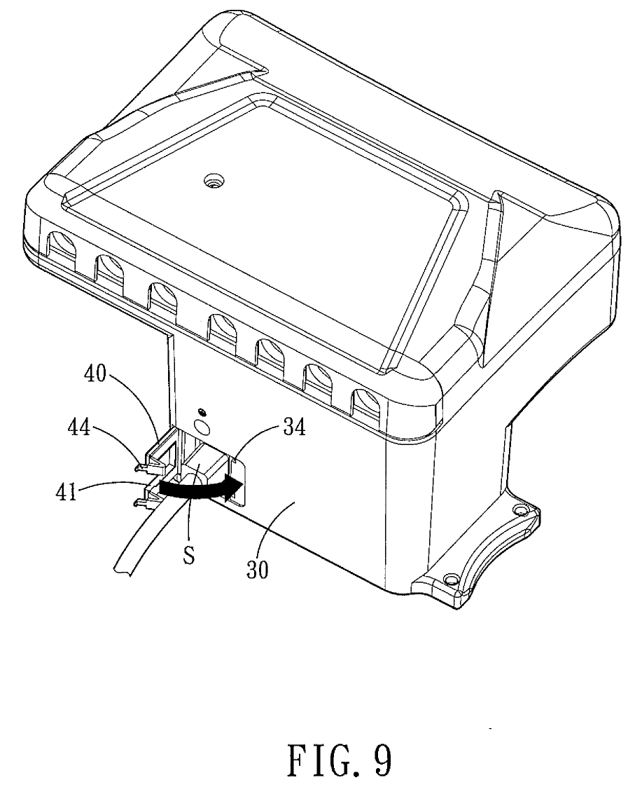

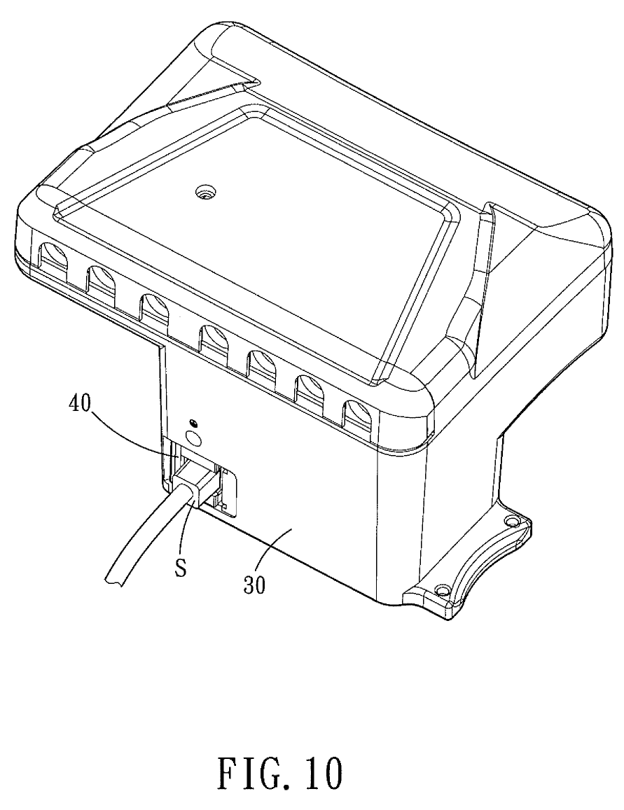

In addition, the anti-pull out structure 40 of the present invention can also be as shown in FIGS. 8-10, the notches 41 are located correspondingly to the socket 31. One end of the anti-pull out structure 40 is pivotally disposed beside the socket 31 of the controller 30, and the other end of the anti-pull out structure 40 is formed with two elastic engaging members 44. The controller 30 is formed with the same number and shape of engaging portions 34 as the elastic engaging members 44. The anti-pull out structure 40 is pivotally, openably and closably secured to the controller 30, and the elastic engaging members 44 are engaged in the engaging portions 34.

When the anti-pull out structure 40 opens and the plug S with a protruding flange S1 is plugged in the socket 31 of the controller 30, the anti-pull out structure 40 can then be closed by rotating to the socket 31 until the elastic engaging members 44 are engaged in the engaging portions 34, and the notch 41 of the anti-pull out structure 40 allows the passage of the plug S. By such arrangements, the protruding flange S1 of the plug S will be restricted in the socket 31 of the controller 30 by the notch 41 of the anti-pull out structure 40.

To summarize, a controller with an anti-pull out structure in accordance with the present invention comprises at least one socket and one plug, the anti-pull out structure is formed with the same number of notches as the socket. The notch is used to restrict the plug in the socket of the controller, which not only prevents the plug from falling off but also prevents improper insertion of the plug into the socket of the controller.

While we have shown and described various embodiments in accordance with the present invention, it is clear to those skilled in the art that further embodiments may be made without departing from the scope of the present invention.

1. A controller with an anti-pull out structure comprising at least one socket and at least one plug detachably plugged in the socket, characterized in that:
the anti-pull out structure is assembled on the controller and located correspondingly to the socket, the anti-pull out structure is defined with at least one notch being located correspondingly to the socket of the controller, the notch is formed correspondingly to the shape of the plug and employed to restrict the plug within the socket of the controller;
the controller is defined with at least one positioning concave, and a concave direction of the positioning concave intersects an inserting direction of the socket, the anti-pull structure is formed with the same number and shape of convex portion as the positioning concave, so that the anti-pull out structure is detachably assembled on the controller.

2. (canceled)

3. (canceled)

4. The controller with an anti-pull out structure as claimed in claim 1, wherein the concave direction of the positioning concave is vertical to the inserting direction of the socket.

5. The controller with an anti-pull out structure as claimed in claim 3, wherein the positioning concave is formed at either end of the controller, and the convex portion is formed at either end of the anti-pull out structure.

6. The controller with an anti-pull out structure as claimed in claim 3, wherein the controller is formed with two protrusions that extend in opposite directions, an extending direction of the protrusions intersects the inserting direction of the socket, and the anti-pull structure is defined with two cavities for mating with the two protrusions of the controller.

7. The controller with an anti-pull out structure as claimed in claim 6, wherein the extending direction of the protrusions is vertical to the inserting direction of the socket.

8. The controller with an anti-pull out structure as claimed in claim 5, wherein the controller is formed with two protrusions that extend in opposite directions, extending direction of the protrusions intersects the inserting direction of the socket, and the anti-pull structure is defined with two cavities for mating with the two protrusions of the controller.

9. The controller with an anti-pull out structure as claimed in claim 8, wherein the extending direction of the protrusions is vertical to the inserting direction of the socket.

10. (canceled)

11. (canceled)
